(19) United States
(12) Patent Application Publication
(10) Pub. No.: US 2019/0223984 A1
(43) Pub. Date: Jul. 25, 2019

(54) DENTAL APPARATUS FOR BONDING ORTHODONTIC APPLIANCE TO DENTAL ARCH AND PROCESS THEREOF

(71) Applicant: GuideMia Technologies Inc., Los Alamitos, CA (US)

(72) Inventors: Ning Dou, Shanghai (CN); Fei Gao, Buena Park, CA (US)

(73) Assignee: GuideMia Technologies Inc., Los Alamitos, CA (US)

(21) Appl. No.: 15/874,882

(22) Filed: Jan. 19, 2018

(51) Int. Cl. A61C 7/14; A61C 7/00

(52) U.S. Cl. CPC A61C 7/146; A61C 7/002

(57) ABSTRACT

The present invention provides a customized guide that can releasably engage with a patient's dental arch. A rigid link, preferably a standard rigid link, is provided to connect the guide and a bracket that is to be adhered to a tooth. With the standard link, the invention exhibits numerous technical merits such as simplified operation, and accurate placement and adhesion of brackets onto teeth, among others.

### CROSS-REFERENCE TO RELATED APPLICATIONS

Not applicable.

### STATEMENT REGARDING FEDERALLY SPONSORED RESEARCH OR DEVELOPMENT

Not applicable.

### NAMES OF PARTIES TO A JOINT RESEARCH AGREEMENT

Not applicable.

### REFERENCE TO AN APPENDIX SUBMITTED ON COMPACT DISC

Not applicable.

### FIELD OF THE INVENTION

The present invention generally relates to a dental apparatus for bonding an orthodontic appliance to a patient's dental arch, and a process thereof. Although the invention will be illustrated, explained and exemplified by a bracket such as a slotted bracket, it should be appreciated that the present invention can also be applied to other fields, for example, slot-less bracket, and the like.

### BACKGROUND OF THE INVENTION

It is known that ran orthodontic treatment can not only improve the patient's facial appearance, especially in instances where the teeth are noticeably crooked or where the jaws are out of alignment with each other, but also enhance the function of the teeth by providing better occlusion during mastication.

Orthodontic procedures typically employ braces to move mal-positioned teeth to desired locations in the oral cavity. The application of braces moves the teeth as a result of force and pressure on the teeth. There are traditionally four basic elements that are used: brackets, bonding material, arch wire, and ligature elastic (also called an “O-ring”). The teeth move when the arch wire puts pressure on the brackets and teeth. Sometimes springs or rubber bands are used to put more force in a specific direction.

Braces have constant pressure which, over time, moves teeth into the desired positions. The process loosens the tooth after which new bone grows in to support the tooth in its new position. This is called bone remodeling. Bone remodeling is a biomechanical process responsible for making bones stronger in response to sustained load-bearing activity and weaker in the absence of carrying a load. When braces put pressure on teeth, the periodontal membrane stretches on one side and is compressed on the other. A tooth will usually move about a millimeter per month during orthodontic movement.

A tiny, slotted component in the brace known as bracket is fixed to a tooth and an archwire is placed in the slot of each bracket The archwire forms a track to guide movement of teeth to desired locations. The precise position of brackets on the teeth is an important factor for helping to ensure that the teeth move to their intended final positions. For example, in “straight-wire” technique, the archwire lies in a horizontal plane at the conclusion of treatment. Consequently, if a bracket is attached to the tooth at a location that is too close to the occlusal or outer tip of the tooth, the orthodontist using a straight-wire technique will likely find that the tooth in its final position is unduly intruded. On the other hand, if the bracket is attached to the tooth at a location closer to the gingiva than appropriate, it is likely that the final position of the tooth will be more extruded than desired.

However, it is procedurally difficult to handle tiny brackets, for example, placing and gluing the bracket onto the tooth at a perfect location and with a perfect orientation. Access to surfaces of mal-posed teeth may be difficult. In some instances, and particularly in connection with posterior teeth, the dentist may have difficulty seeing the precise position of the bracket relative to the tooth surface. Moreover, a significant length of time is needed to carry out the procedure of bonding each bracket to each individual tooth. Typically, the dentist will attempt to ensure that each bracket is positioned in its precise, intended location before the adhesive is cured, and some amount of time may be necessary before the dentist is satisfied with the location of each appliance. At the same time, however, the patient may experience discomfort during the procedure and have difficulty in remaining relatively motionless. These can be considered a nuisance for both the dentist and for the patient.

Therefore, there exists a need to overcome the aforementioned problems. Advantageously, the present invention provides a dental apparatus and a dental process which exhibits numerous technical merits such as simplified operation, and accurate placement and adhesion of brackets onto teeth, among others.

### SUMMARY OF THE INVENTION

One aspect of the present invention provides a dental apparatus used for bonding an orthodontic appliance having a bonding surface configured for bonding to a patient's dental arch such as a tooth. The dental apparatus comprises a customized guide and a rigid link. The customized guide includes (1) a matching construction that matches, and can releasably engage or mate with, at least a portion of the patient's dental arch, and (2) at least one customized connecting structure. The rigid link links or connects the customized connecting structure to the orthodontic appliance. The rigid link comprises a first connector and a second connector, wherein the first connector releasably engages with the customized connecting structure, and the second connector can releasably engage with the orthodontic appliance. The customized connecting structure is customized based on the bonding surface's bonding position and orientation on the dental arch such as the tooth.

Another aspect of the invention provides an orthodontic process (e.g a CAD/CAM process) for bonding an orthodontic appliance to a patient's dental arch such as a tooth comprising:

(a) providing a digital anatomy representing at least the patient's dental arch such as a tooth;

(b) providing a digital appliance representing an orthodontic appliance having a bonding surface configured for bonding to the patient's dental arch such as a tooth,

(c) determining the bonding surface's bonding position and orientation on the patient's dental arch such as a tooth;

(d) providing a digital link representing a rigid link which comprises a first connector and a second connector, wherein the second connector can releasably engage with said orthodontic appliance 10;

(e) digitally engaging the second connector with said orthodontic appliance, whereby a spatial relationship between the first connector and the bonding surface's bonding position and orientation on the patient's dental arch such as a tooth is established and fixed;

(f) designing and manufacturing a customized rigid guide including a matching construction that matches, and can releasably engage with, at least a portion of the patient's dental arch such as a tooth, and at least one customized connecting structure, wherein, when the first connector engages with said customized connecting structure, a spatial relationship between said customized connecting structure and the bonding surface's bonding position and orientation on the patient's dental arch such as a tooth is established and fixed;

(g) securing the orthodontic appliance to the rigid link by engaging the orthodontic appliance with the second connector; and securing the rigid link to the customized rigid guide by engaging the first connector with said customized connecting structure;

(h) placing the orthodontic appliance, the rigid link and said customized connecting structure that are already secured together, onto the patient's dental arch such as a tooth, wherein the matching construction engages with said at least a portion of the patient's dental arch such as a tooth; and

(i) bonding the orthodontic appliance to the patient's dental arch such as a tooth.

Still another aspect of the invention provides an orthodontic rigid link comprising a body, a first connector, and a second connector for linking or connecting a customized connecting structure to an orthodontic appliance. The first connector releasably engages with the customized connecting structure, and the second connector can releasably engage with the orthodontic appliance.

The above features and advantages and other features and advantages of the present invention are readily apparent from the following detailed description of the best modes for carrying out the invention when taken in connection with the accompanying drawings.

### BRIEF DESCRIPTION OF THE SEVERAL VIEWS OF THE DRAWINGS

The present invention is illustrated by way of example, and not by way of limitation, in the figures of the accompanying drawings and in which like reference numerals refer to similar elements All the figures are schematic and generally only show parts which are necessary in order to elucidate the invention. For simplicity and clarity of illustration, elements shown in the figures and, discussed below have not necessarily been drawn to scale Well-known structures and devices are shown in simplified form, omitted, or merely suggested, in order to avoid unnecessarily obscuring the present invention,

FIG. 1 schematically shows a dental apparatus in accordance with an exemplary embodiment of the present invention.

FIG. 2 illustrates a “single-link” design of the dental apparatus in accordance with an exemplary embodiment of the present invention.

FIG. 3A illustrates a “multiple-link” design of the dental apparatus in accordance with an exemplary embodiment of the present invention.

FIG. 3B illustrates a “multiple-link” design of the dental apparatus in accordance with an exemplary embodiment of the present invention.

FIG. 4 demonstrates a bracket that can be guided to a predetermined position on ra tooth in accordance with an exemplary embodiment of the present invention.

FIG. 5 depicts a rigid link in accordance with an exemplary embodiment of the present invention.

FIG. 6 schematically shows that the rigid link in FIG. 5 is intimately but releasably engaged with the bracket in FIG. 4.

FIG. 7 illustrates a customized guide configured for releasably engaging with the rigid link FIG. 5 in accordance with an exemplary embodiment of the present invention.

FIG. 8 illustrates four pieces (guide, link, appliance and tooth) that are releasably mated together with a defined spatial relationship in accordance with an exemplary embodiment of the present invention.

FIG. 9 illustrates a simplified rigid link in accordance with an exemplary embodiment of the present invention.

FIG. 10 is a perceptive view of the simplified rigid link in FIG. 9.

FIG. 11 illustrates the configurations of a bracket and a simplified rigid link before they are engaged with each other in accordance with an exemplary embodiment of the present invention.

FIG. 12 illustrates the configurations of a bracket and a simplified rigid link after they are engaged with each other in accordance with an exemplary embodiment of the present invention.

FIG. 13 is another view of the configurations of a bracket and a simplified rigid link after they are engaged with each other in FIG. 12.

FIG. 14 shows a bracket and a simplified rigid link are secured with a rubber band in accordance with an exemplary embodiment of the present invention

FIG. 15 is a flow chart of an orthodontic process using a general dental apparatus in accordance with an exemplary embodiment of the present invention.

FIG. 16 is a flow chart of an orthodontic process using a “single-link” design of dental apparatus in accordance with an exemplary embodiment of the present invention.

FIG. 17 is a flow chart of an orthodontic process using a “multiple-link” design of dental apparatus in accordance with an exemplary embodiment of the present invention.

### DETAILED DESCRIPTION OF THE PREFERRED EMBODIMENT

In the following description, for the purposes of explanation, numerous specific details are set forth in order to provide a thorough understanding of the present invention. It is apparent, however, to one skilled in the art that the present invention may be practiced without these specific details or with an equivalent arrangement

Where a numerical range is disclosed herein, unless otherwise specified, such range is continuous, inclusive of both the minimum and maximum values of the range as well as every value between such minimum and maximum values. Still further, where a range refers to integers, only the integers from the minimum value to and including the maximum value of such range are included. In addition, where multiple ranges are provided to describe a feature or characteristic, such ranges can be combined.

It is also to be understood that the terminology used herein is for the purpose of describing particular embodiments only, and is not intended to limit the scope of the invention. For example, when an element is referred to as being “on”, “connected to”, or “coupled to” another element, it can be directly on, connected or coupled to the other element or intervening elements may be present. In contrast, when an element is referred to as being “directly on”, “directly connected to”, or “directly coupled to” another element, there are no intervening elements present.

The terms “releasably engage”, “releasably connect”, “releasably mate”, “releasably conform to”, and “releasably fit into” are interchangeable in the present description.

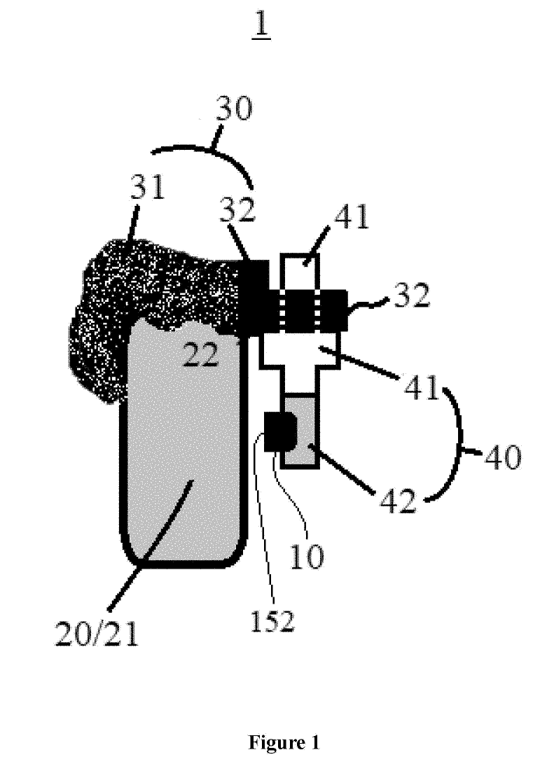

As shown in FIG. 1, a dental apparatus 1 includes a customized guide 30 and a rigid link 40. The dental apparatus is used for bonding an orthodontic appliance 10 having a bonding surface 152 configured for bonding to a patient's dental arch 20 such as a tooth 21 The customized guide 30 including a matching construction 31 that matches, and can releasably engage with, at least a portion 22 of the patient's dental arch 20, and at least one customized connecting structure 32. The rigid link 40 functions for linking or connecting or bridging customized connecting structure 32 to orthodontic appliance 10. The rigid link 40 includes a first connector 41 and a second connector 42, wherein the first connector 41 releasably engages with the customized connecting structure 32, and the second connector 42 can releasably engage with the orthodontic appliance 10, The connecting structure 32 is customized according to the bonding surface 152's bonding position and orientation on the dental arch 20 such as the tooth 21, There are four “mating relationships” in FIG. 1: between matching construction 31 and a portion 22 of the patient's dental arch, between the first connector 41 and the customized connecting structure 32, between the second connector 42 and orthodontic appliance 10, and between bonding surface 152 and its bonding area on the dental arch 20 such as the tooth 21. The customized guide 30, the rigid link 40, appliance 10, and the dental arch 20 are all sufficiently rigid so that the spatial relationship between one part of the guide 30, link 40, appliance 10 or dental arch 20 and another remains fixed for the purpose of executing the orthodontic process of the invention. The minimum rigidity of the guide, link, the appliance and the dental arch (10, 20, 30, 40, hereinafter “four pieces”), combined with the four spatial relationships established and fixed based on four “mating relationships” above will ensure that the assembly of the four pieces (when perfectly and snugly mated) in a digital environment will be accurately translated/duplicated/replicated into the physical environment. Broadly speaking, it would suffice as long as the spatial relationships established and fixed between the dental arch 20 and two components (i.e. matching construction 31 and bonding surface 152) in a digital environment can be accurately translated/duplicated/replicated into the physical environment. For simplicity, four physical pieces may be termed as physical guide, physical link, physical appliance, and physical dental arch (10, 20, 30, 40), and four digital pieces may be termed as digital guide, digital link, digital appliance, and digital dental arch (10, 20, 30, 40), which are particular useful and convenient for describing a CAD/CAM process of the invention.

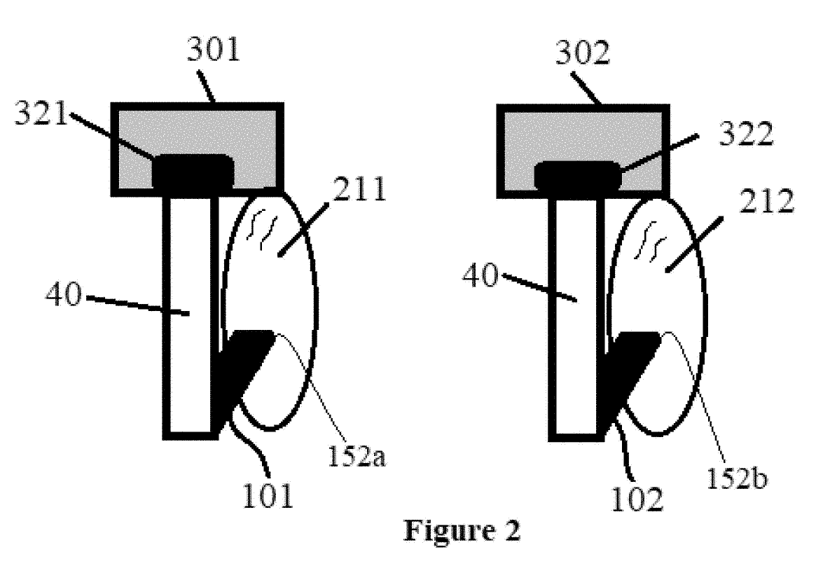

In an embodiment as shown in FIG. 2, a “single-link” design of the dental apparatus is used for bonding a first orthodontic appliance 101 having a first bonding surface 152a and a second orthodontic appliance 102 having a second bonding surface 152b, to a patient's a first tooth 211 and a second tooth 212 respectively. In the “single-link” design, a first customized guide 301 includes only a first customized connecting structure 321. A second customized guide 302 includes only a second customized connecting structure 322. The first customized guide 301 is separated from the second customized guide 302 (i.e. they are two independent and separated pieces, digitally or physically). Two rigid links 40 are identical to each other and are used for linking the first and second customized connecting structures (321, 322) to the first and second orthodontic appliances (101, 102) respectively. When such two or more rigid links 40 are identical to each other, they can be called standard rigid links 40. Throughout the present description, links 40 may be standard regardless of patient's anatomy, or customized to patient's anatomy. The first connecting structure 321 is customized according to the first bonding surface 152a's bonding position and orientation on the first tooth 211, and likewise, the second connecting structure 322 is customized according to the second bonding surface 152b's bonding position and orientation on the second tooth 212.

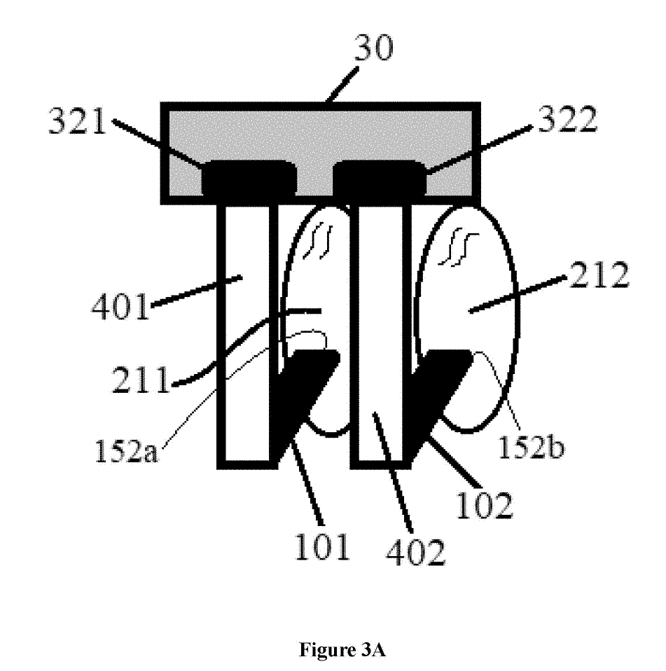

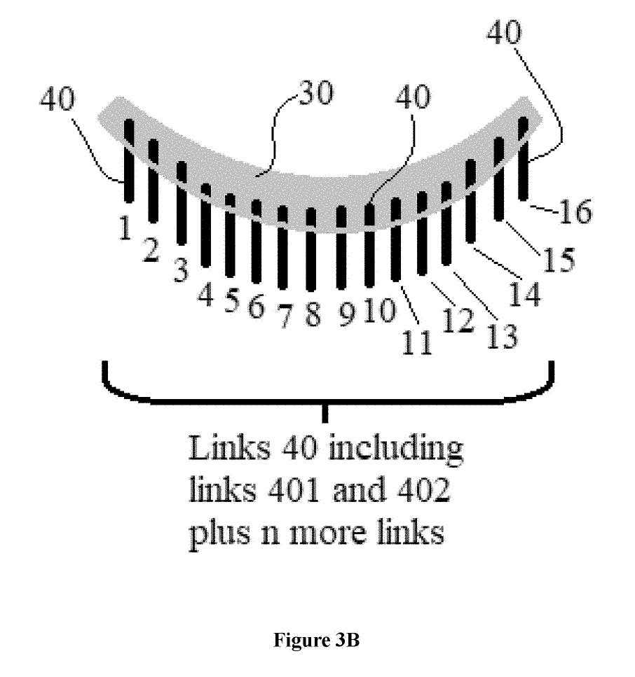

In an embodiment as shown in FIG. 3A, a “multiple-link” design of the dental apparatus is also used for bonding a first orthodontic appliance 101 and a second orthodontic appliance 102 to a patient's a first tooth 211 and a second tooth 212 respectively. However, the customized guide 30 includes both first customized connecting structure 321 and second customized connecting structure 322. Similarly, two rigid links 40 (a first rigid link 401 and a second rigid link 402) are separate to each other for linking the first and second customized connecting structures (321, 322) to the first and second orthodontic appliances (101, 102) respectively. The first connecting structure 321 is customized according to the first bonding surface 152a's bonding position and orientation on the first tooth 211, and the second connecting structure 322 is customized according to the second bonding surface 152b's bonding position and orientation on the second tooth 212. The first rigid link 401 and the second rigid link 402 in FIG. 3A may be identical to each other, or they may be two rigid links 40 with different structure, shape and dimension. Again, when such two rigid links 40 in FIG. 3A are identical to each other, they can be called standard rigid links 40.

The dental apparatus as shown in FIG. 3A may be expanded for bonding n more orthodontic appliances than those shown in FIG. 3A, to a patient's n more teeth than those shown in FIG. 3A, respectively. As a result, the customized guide 30 further includes n more customized connecting structures than those shown in FIG. 3A. Referring to FIG. 3B, the dental apparatus comprises, in addition to the first rigid link 401 and the second rigid link 402, n more number of said rigid links 40 that are separate from each other for linking said n more customized connecting structures to said n more orthodontic appliances respectively. Each of said n more customized connecting structures is customized according to bonding position and orientation of a bonding surface in a corresponding orthodontic appliance selected from said n more orthodontic appliances on a corresponding tooth selected from said n more teeth. The number n can be any number between 1 and 14, 1≤n≤14, such as 2≤n≤14, 3≤n≤14, 423 n≤14, 5≤n≤14, 6≤n≤14, 7≤n≤14, 8≤n≤14, 9≤n≤14, 10≤n≤14, 11≤n≤12≤n≤14 such as n=13.

The first rigid link 401, the second rigid link 402, as well as the n more rigid links 40 may be all identical to each other. Alternatively, some of the links are identical, while others are not Each of the links can be unique in its own way, and none of the two links are identical,

The embodiments of the invention as shown in FIG. 3B exhibit numerous advantages over jigs used in the prior art. For example, as the number n is increasing, it becomes increasingly difficult for a dentist to engage/disengage the traditional jig onto/front the patient dental arch. In contrast, the “multiple-link” design of the present invention can be engaged onto and disengaged from the patient dental arch with no difficulty at all, particularly when n is relatively higher, e.g 5≤n≤14, 6≤n≤14, 7≤n≤14, 8≤n≤14, 9≤n≤14, 10≤n≤14, 11≤n≤14, 12—n≤14 such as n=13.

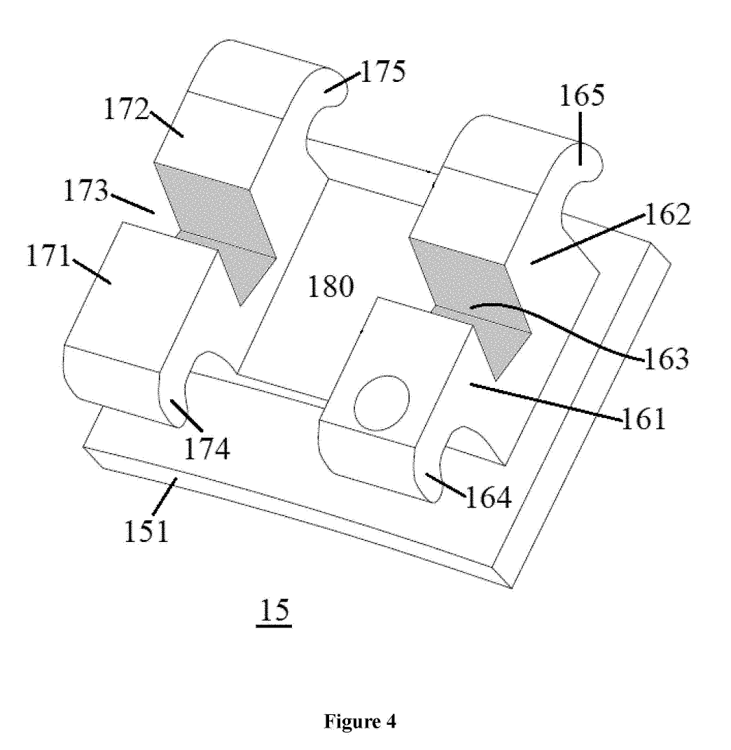

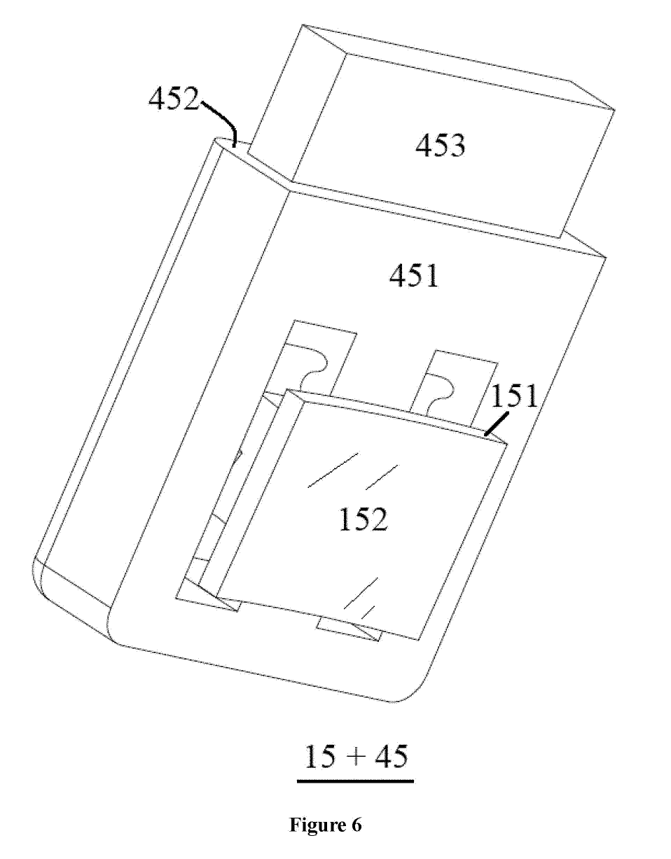

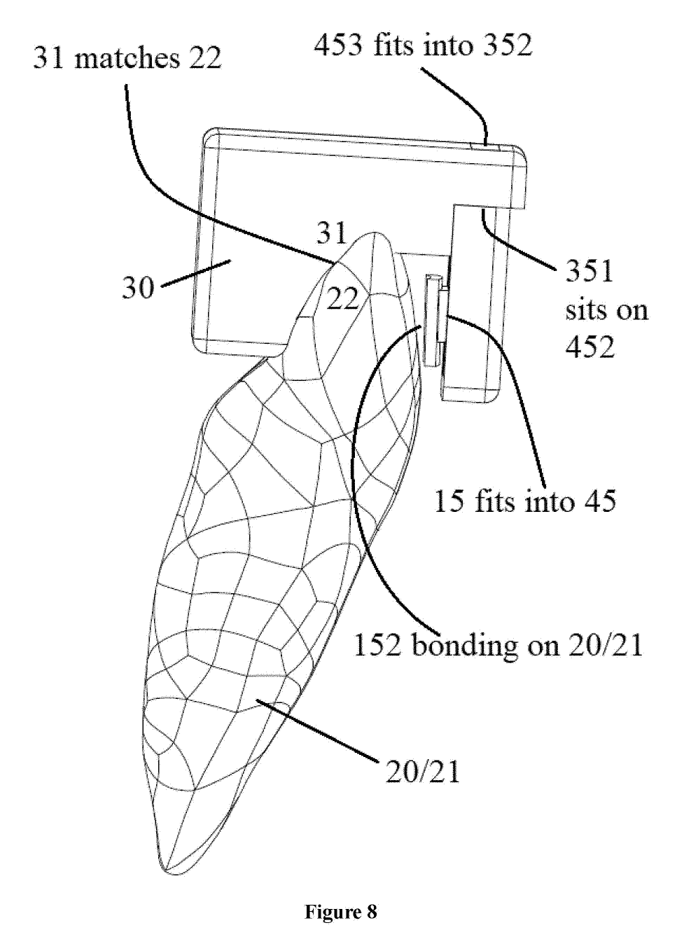

In FIGS. 4-14, the orthodontic appliance 10 will be exemplified as a slotted bracket 15. However, the orthodontic appliance 10 may be other examples such as a slot-less bracket. Referring to FIG. 4, the bracket 15 includes a base 151 having a bonding surface 152 (see FIGS. 6 and 8) configured for bonding to a patient's dental arch 20 such as a tooth 21 (see FIG. 1). A first pair of arms (161, 162) extends from the base 151, forming a first slot 163 between the two arms (161, 162). The two arms (161, 162) may be the same or different from each other. Likewise, a second pair of arms (171, 172) extends from the base 151, forming a second slot 173 between two arms (171, 172). The slots 163 and 173 are usually archwire slots. A valley 180 is formed between the first pair of arms (161, 162) and the second pair of arms (171, 172) In preferred embodiments, a first pair of hooks or barbs (164, 165) extends from the first pair of arms (161, 162) respectively, and a second pair of hooks or barbs (174, 175) extends from the second pair of arms (171, 172) respectively. The hooks or barbs (164, 165, 174, 175) may be used as tiewings for the orthodontic treatment.

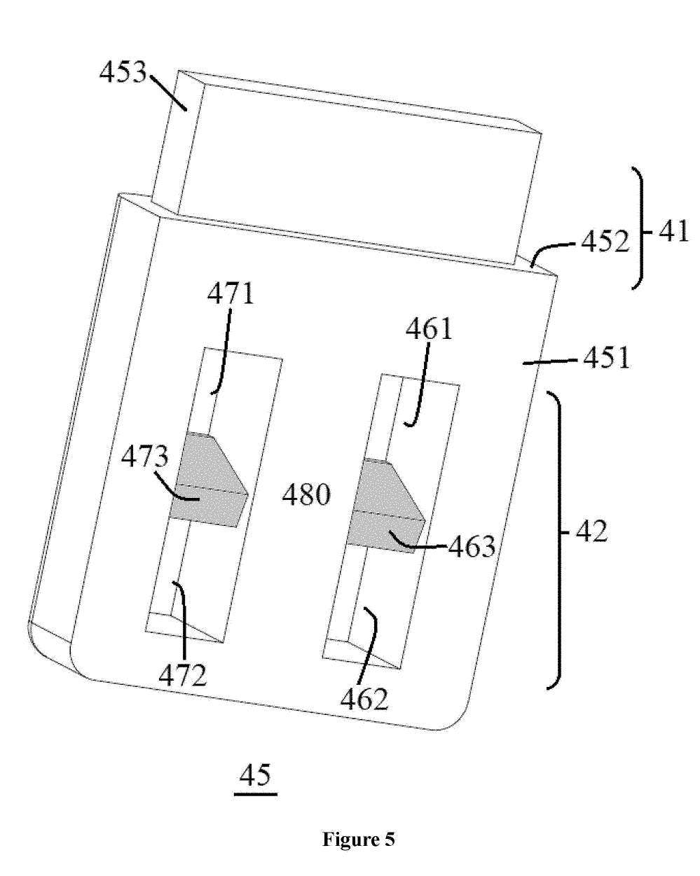

With reference to FIG. 5, the rigid link 45 is configured for releasably engaging with the bracket as shown in FIG. 4. A benefit of the rigid link 45 is that it can facilitate the gripping of the bracket 15 when the two are engaged with each other. Link 45 comprises a body 451, a first connector 41, and a second connector 42. The second connector 42 comprises a first pair of pockets (461, 462) configured for the first pair of arms (161, 162) and optional hooks or barbs (164, 165) as shown in FIG. 4 to releasably fit into A first insert 463 is formed between the first pair of pockets (461, 462), and'the first insert 463 is configured for releasably fitting into the first slot 163 in FIG. 4. Likewise, a second pair of pockets (471, 472) is configured for the second pair of arms (171, 172) and optional hooks or barbs (174, 175) in FIG. 4 to releasably fit into. A second insert 473 is formed between the second pair of pockets (471, 472), and the second insert 473 is configured for fitting into the second slot 173 in FIG. 4. A ridge 480 is formed between (A) the first pair of pockets (461, 462) and the first insert 463 therebetween and (B) the second pair of pockets (471, 472) and the second insert 473 therebetween. The ridge 480 is configured for releasably fitting into the valley 180 in FIG. 4 FIG. 6 shows that the rigid link 45 as shown in FIG. 5 is intimately but releasably engaged with bracket 15 as shown in FIG. 4. The rigid link 45 in FIGS. 5-6 includes a body 451, a first connector 41, and a second connector 42. The first connector 41 comprises a shoulder 452 and a head 453 extending from the body 451

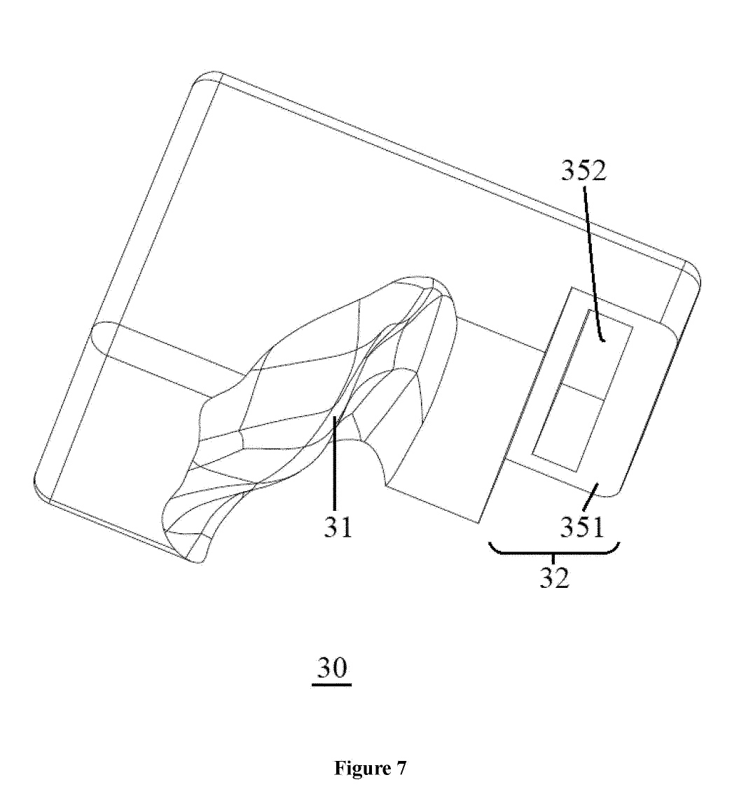

In the embodiment as shown in FIG. 7, the customized guide 30 is configured for releasably engaging with the rigid link 45 in FIG. 5. Guide 30 includes a matching construction 31 that matches, and can releasably engage with, at least a portion 22 of the patient's dental arch 20 such as a tooth 21 (see FIG. 8), and at least one customized connecting structure 32 Connecting structure 32 includes a flange 351 having at least one aperture 352 through the flange 351. The head 453 can releasably insert and fit into the aperture 352 until the flange 351 contacts or sits on the shoulder 452. FIG. 8 shows the four pieces' guide, link, appliance and tooth (10, 21, 30, and 40) are releasably mated together with a defined spatial relationship. The assembly of the four pieces (when perfectly and snugly mated) in a digital environment in a designing center will be accurately translated/duplicated/replicated into the physical environment. The physical guide 30 may be custom made, while the physical link 40 and/or the physical appliance 10/15 may be either custom made or mass produced, as long as the spatial relationships established and fixed between the dental arch 20 and two components (i.e. matching construction 31 and bonding surface 152) in the digital environment have been accurately translated/duplicated/replicated into the physical environment. When the physical link 40 is a standard link, it is preferably mass produced on an industrial scale, and widely distributed to dentists' offices and dental labs for using with dental guides 30 and appliances 10.

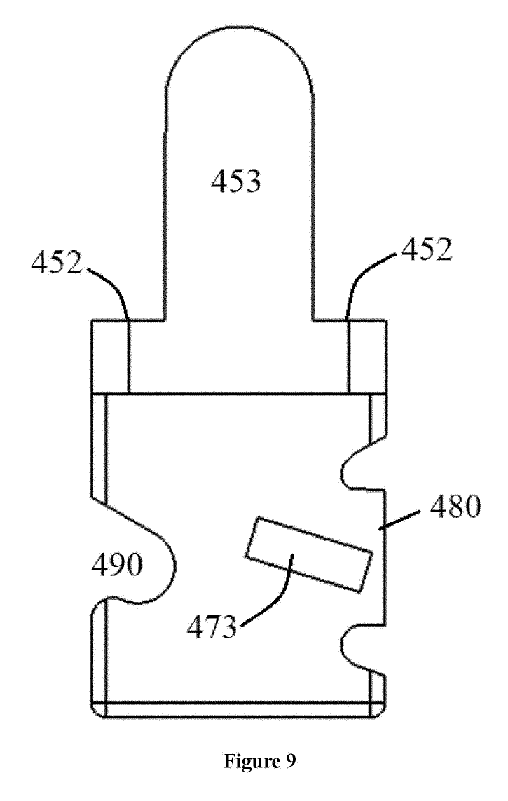

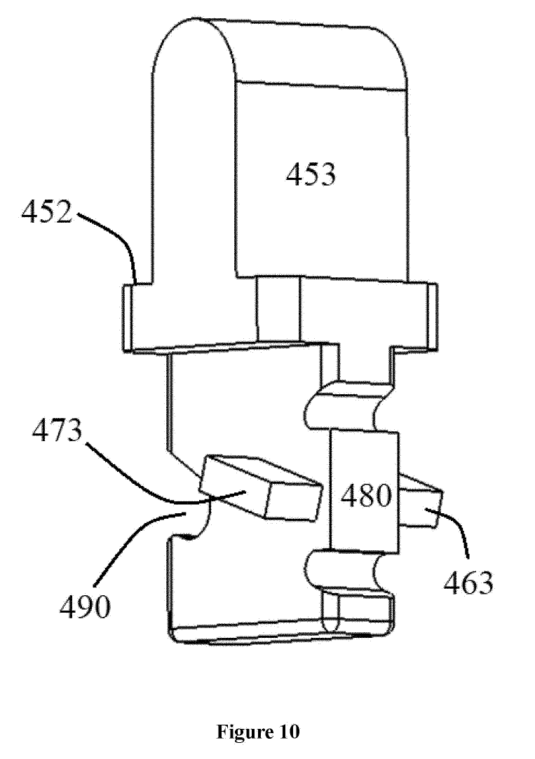

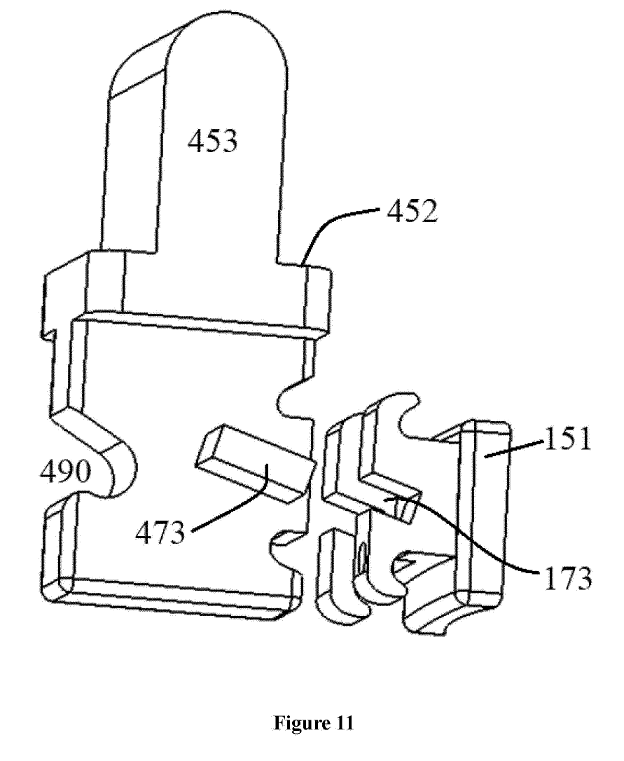

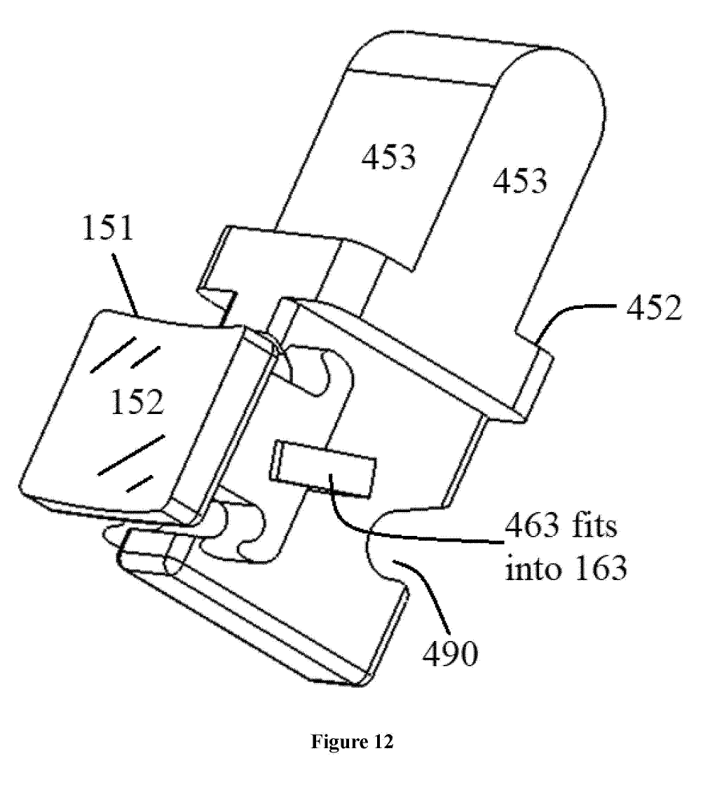

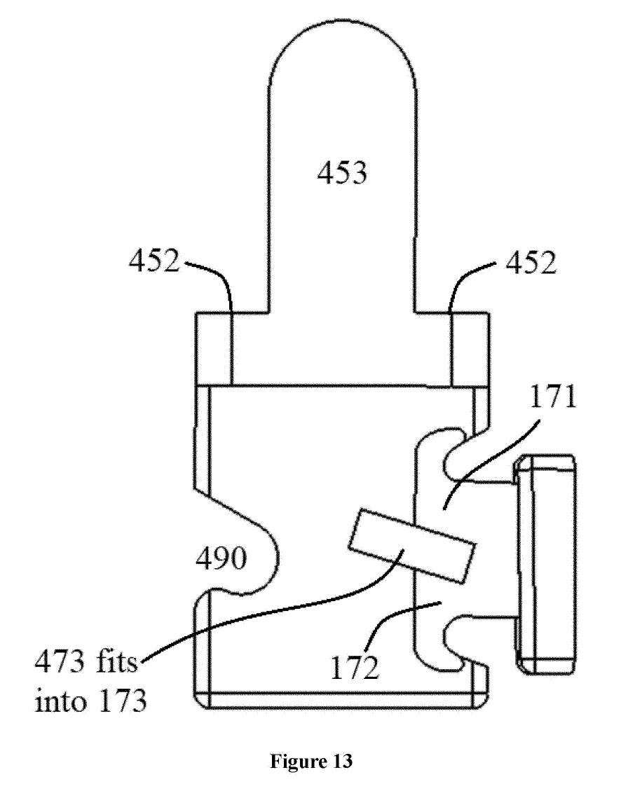

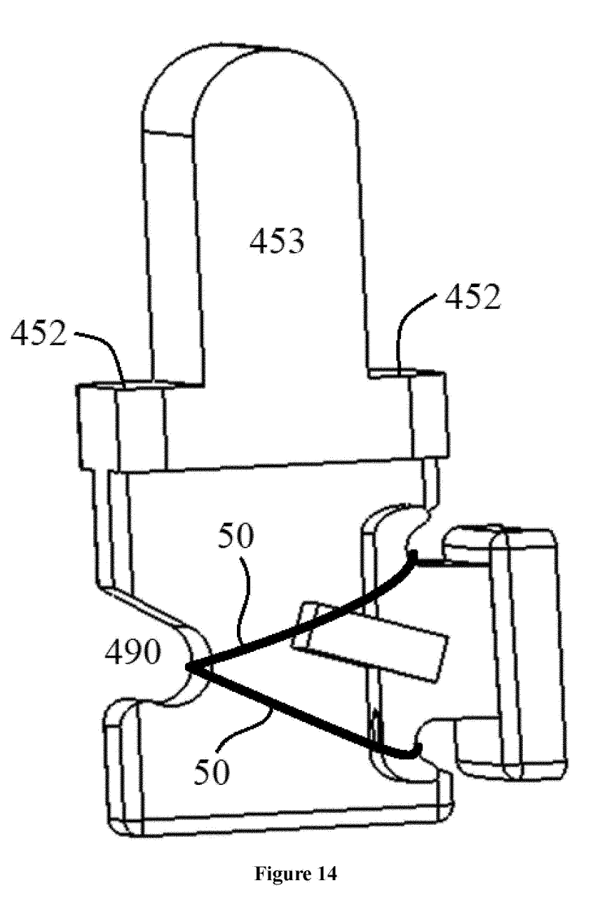

In other embodiments a shown in FIGS. 9-11, the rigid link 45 is alternatively configured for releasably engaging with the bracket in FIG. 4, and comprises a body 451, a first connector 41, and a second connector 42. The second connector 42 comprises a plate-shaped ridge 480 having two sides, a first insert 463 is attached or hanged to one side of the ridge 480, and a second insert 473 is attached to another side of the ridge 480. As shown in FIG. 11, the first insert 463 is configured for releasably fitting into the first slot 163 in FIG. 4; and the second insert 473 is configured for releasably fitting into the second slot 173 in FIG. 4. The ridge 480 is configured for releasably fitting into the valley 180 in FIG. 4. FIGS. 12 and 13 show that the rigid link 45 as shown in FIGS. 9 and 10 is intimately but releasably engaged with bracket 15 as shown in FIG. 4. in a specific embodiment a shown in FIG. 14, the body 451 comprises a groove 490, and a rubber band 50 can wrap around the body 451 and the bracket 15 through the groove 490 so as to secure the body 451 and the bracket 15 together. Likewise, the rigid link 45 in FIGS. 9-14 also includes a body 451, a first connector 41, and a second connector 42. The first connector 41 comprises a shoulder 452 and a head 453 extending from the body 451.

The first insert 463, the second insert 473 and the ridge 480 may take the suitable shape of bars, posts or other structure as long as they contact the bracket 15 and prevent undue movement. Alternatively or additionally, some sidewalls of the four pockets (461, 462, 471, 472) may contact the bracket 15 and prevent undue movement.

Various embodiments of the invention provide an orthodontic process using the dental apparatus as shown in FIG. 1 for bonding an orthodontic appliance 10 to a patient's dental arch 20 such as a tooth 21 Such operations, tasks, and functions, particularly those associated with. CAD/CAM technology, are sometimes referred to as being partially or entirely computer-executed, computerized, processor-executed, software-implemented, or computer-implemented. Techniques and technologies may be described herein in terms of functional and/or logical block components, and with reference to symbolic representations of operations, processing, tasks, and functions that may be performed by various computing components or devices. It should be appreciated that the various block components shown in the figures may be realized by any number of hardware, software, and/or firmware components configured to perform the specified functions. For example, an embodiment of a system or a component may employ various integrated circuit components, e.g., memory elements, digital signal processing elements, logic elements, look-up tables, or the like, which may carry out a variety of functions under the control of one or more microprocessors or other control devices.

When implemented in software or firmware, various elements of the systems described herein are essentially the code segments or executable instructions that, when executed by one or more processor devices, cause the host computing system to perform the various tasks In certain embodiments, the program or code segments are stored in a tangible processor-readable medium, which may include any medium that can store or transfer information. Examples of suitable forms of non-transitory and processor-readable media include an electronic circuit, a semiconductor memory device, a ROM, a flash memory, an erasable ROM (FROM), a floppy diskette, a CD-ROM, an optical disk, a hard disk, or the like.

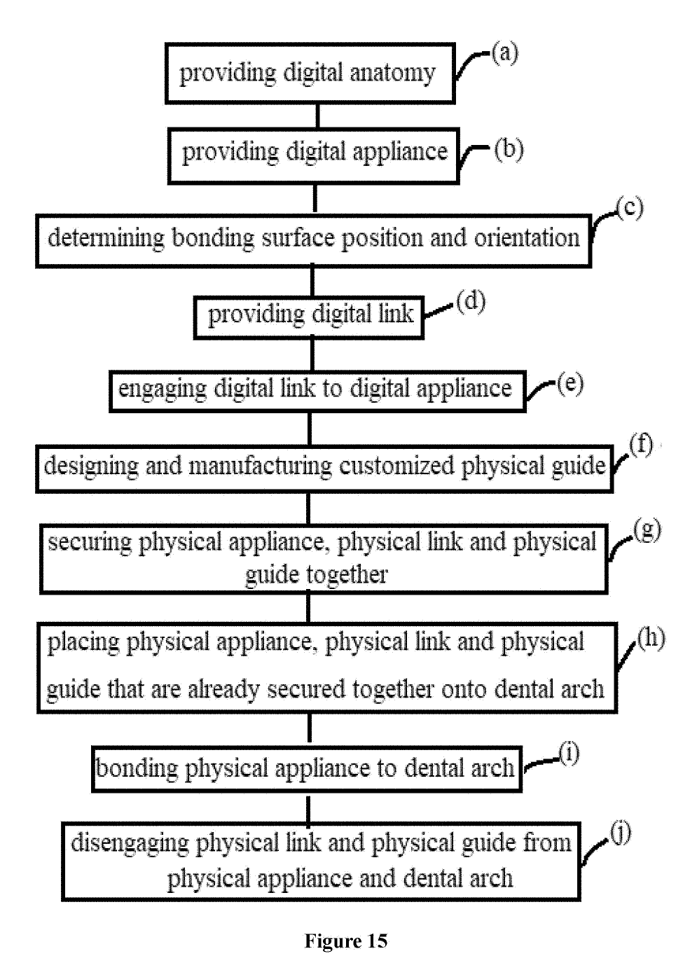

As shown in the flow chart of FIG. 15, step (a) is providing a digital anatomy representing at least the patient's dental arch 20 such as a tooth 21. In a doctor's office, a patient who requires orthodontic treatment is examined by an orthodontist, who makes a diagnosis of the condition of the patient and of the treatment, and prepares detailed records of the anatomy and condition of the mouth of the patient, of the treatment proposed, and of other information necessary to the preparation of an orthodontic appliance. Digital treatment starts with the creation of a three-dimensional digital model or digital anatomy of the patient's arches. This model may be produced by laser-scanning plaster models created using dental impressions Computer-automated treatment simulation has the ability to automatically separate the gums and teeth from one another and can handle malocclusions well. This software enables clinicians to ensure, in a virtual setting, that the selected treatment will produce the optimal outcome.

A physical model from a mold of the patient's mouth includes a mandibular model of the patient's lower jaw or mandible and a maxillary model of the patient's upper jaw or maxilla. Alternatively, the orthodontist provides a digital anatomy by digitizing data from the physical model (e.g. a stone model), or by a hand-held intra-oral scanning using video cameras, mechanical probes, laser scanners, ultrasonic scanners, moire image scanners or other forms of imaging or measurement hardware that alone, or in combination with CT and MRI data, produce anatomical geometric information that describes the patient's teeth and jaw. The images may be three-dimensional or be made along a plurality of planes or other surfaces that can ultimately be combined to provide information in three dimensions.

The digital anatomy provides a basis for three-dimensional analysis of the patient's teeth and from which calculations of finish tooth positions can be made. From the final positional calculations and tooth anatomy data, automatic design and manufacture of the custom orthodontic appliance 10 is carried out. The orthodontist prescribes a treatment to be applied to the patient and a result to be achieved by the treatment. The prescription may also include a specification of techniques that are to be included in the treatment and a designation of an orthodontic appliance to be employed. The finish position of the teeth is calculated and a custom orthodontic appliance 10 is designed and manufactured.

Known technology such as software-implemented method may be employed in steps (b) and (c). Step (b) is providing a digital appliance representing an orthodontic appliance 10 having a bonding surface 152 configured for bonding to the patient's dental arch 20 such as a tooth 21. Step (c) is determining the bonding surface 152′s bonding position and orientation on the patient's dental arch 20 such as a tooth 21.

Based on the digital anatomy, the final position of the patient's teeth, and the configuration of the appliance 10 (particularly the bonding surface 152 and its bonding position and orientation on the patient's dental arch 20 such as a tooth 21) required to move the patient's teeth to this final or finish position. For example, tooth shape information can be achieved by imaging carefully selected profiles of the teeth. Profiles are produced by outlining the tooth crown surfaces along a vertical plane or other similarly oriented surface that extends in a labial-lingual direction generally perpendicular to the arch of the teeth in the respective jaw For the single cusp anterior teeth, this surface is generally a surface bisecting the tooth and through the crown long axis (CLA) of the tooth For multiple cusp teeth, the same generally applies except modification or displacement of the surface is intelligently made on some teeth to pick up the highest cusp or a marginal ridge that is relevant to development of the proper occlusion For most calculations, the tooth features profile can be assumed to be on a plane through the tooth centerline, even when they are not. For each tooth, profile data is taken in separate X-Y coordinates that relate only to the selected surface or plane. In the course of the analysis and calculation of finish tooth position, these planes are separately translated and reoriented with respect to those of the other teeth and those of the trough and archforms, in several steps, until the ultimate interplane relationships are established The calculation of the finish positions of the teeth may include determining the relative positions of geometric landmarks on the surfaces of the teeth and establishing the axis inclinations of the teeth, calculating cuspid rise, initially positioning the mandibular teeth vertically and in relation to the mandibular trough, calculating a best fit cusp tip equation for the mandibular teeth, calculating the finish positions of the mandibular teeth on the best fit equation, and calculating the finish positions of the maxillary teeth on three arches related to the best fit equation. The appliance design procedure may include determining the location of the mandibular archwire plane relative to the calculated finish positions of the mandibular teeth, calculating the angle of each mandibular bracket slot relative to the mounting surface of the respective tooth, determining the location of the maxillary archwire plane relative to the calculated finish positions of the maxillary teeth, calculating the angle of each maxillary bracket slot relative to the mounting surface of the respective tooth, calculating the shape of the mandibular archwire and the slot in-out dimension of each mandibular bracket, and calculating the shape of the maxillary archwire and the slot in-out dimension of each maxillary bracket.

For example, the slot inclination angle for the mandibular brackets is calculated from the angle between the mandibular archwire plane and'the angle of the mandibular tooth surface to which the base of the bracket is to be mounted. The slot inclination angle may be achieved by cutting the full angle into the slot, by inclining the bracket base, or by both of these methods. Likewise, the slot inclination angle for the maxillary brackets is calculated from the angle between the maxillary archwire plane and the angle of the maxillary tooth surface to which the base of the bracket is to be'mounted. The slot inclination angle may be achieved by cutting the full angle into the slot, by inclining the bracket base, or by both of these methods

Physical brackets may be manufactured by cutting custom slots in bracket blanks while preserving the base inclination angle. Brackets could be alternatively fabricated by inclining the bracket bases or pads Additionally, bonding surface 152 may be contoured to conform to the surfaces of the teeth, or a bonding agent may fill the space between the bracket base and the tooth.

Preferably, the brackets are placed according to the three criteria. 1. Height: the height is established so that the appliance causes the upper and lower teeth to contact each other in the prescribed manner 2. Mesio-Distally: The mesio-distal location is established so that the mesial and distal ridges of the teeth are parallel to the archform for that patient. 3 Long Axis: The bracket is aligned relative to the long axis of the tooth so that the appliance system tips the tooth to the desired angle relative to the archwire For example, brackets slots are not necessarily perpendicular to the long axis of the tooth but at varying degrees of cant.

A computer produces CNC machine readable code for operating a manufacturing equipment to produce the appliance 10. The manufacturing equipment may include an appliance bracket cutting or forming machine which produces custom brackets by cutting slots calculated angles. The machine may also or alternatively shape bonding surface 152 of the bracket bases.

Referring back to FIG. 15, step (d) is providing a digital link representing a rigid link 40 which comprises a first connector 41 and a second connector 42, wherein the second connector 42 can releasably engage with said orthodontic appliance 10. Step (e) is digitally engaging the second connector 42 with said orthodontic appliance 10, whereby a spatial relationship between the first connector 41 and the bonding surface 152′s bonding position and orientation on the patient's dental arch 20 such as a tooth 21 is established and fixed.

Referring to FIG. 15, step (f) is designing and manufacturing a customized rigid guide 30 including a matching construction 31 that matches, and can releasably engage with, at least a portion 22 of the patient's dental arch 20 such as a tooth 21, and at least one customized connecting structure 32, wherein, when the first connector 41 engages with said customized connecting structure 32, a spatial relationship between said customized connecting structure 32 and the bonding surface 152's bonding position and orientation on the patient's dental arch 20 such as a tooth 21 is established and fixed. Matching construction 31 has a surface contour that is a replica of a contour of the patient's tooth 21. Therefore, construction 31 matches and can releasably engage with, at least a portion 22 of the patient's dental arch 20 such as tooth 21.

Step (g) in FIG. 15 is securing the orthodontic appliance 10 to the rigid link 40 by engaging the orthodontic appliance 10 with the second connector 42; and securing the rigid link 40 to the customized rigid guide 30 by engaging the first connector 41 with said customized connecting structure 32. Step (h) is placing the orthodontic appliance 10, the rigid link 40 and said customized connecting structure 32 that are already secured together, onto the patient's dental arch 20 such as a tooth 21, wherein the matching construction 31 engages with said at least a portion 22 of the patient's dental arch 20 such as a tooth 21.

The bracket 15 may be made of any one of a number of materials suitable for use in the oral cavity and having sufficient strength to withstand the correction forces applied during treatment. Suitable materials include, for example, metallic materials (such as stainless steel), ceramic materials (such as monocrystalline or polycrystalline alumina) and plastic materials (such as fiber-reinforced polycarbonate). Step (i) in FIG. 15 is bonding the orthodontic appliance 10 to the patient's dental arch 20 such as a tooth 21

The bonding surface 152 is configured for bonding to a patient's dental arch 20 such as a tooth 21. For example, bonding surface 152 may have a concave contour that is a replica of the convex contour of the portion of the patient's tooth 21 that represents the ultimate desired location of bracket 15 on the tooth 21. The concave contour of bonding surface 152 may be a compound concave contour (i.e., curved in directions along two mutually perpendicular reference axes).

The bracket 15 may be applied with dental cement, and then cured with light until hardened. Once bracket 15 is in its precise, intended location, bracket 15 is pressed firmly onto the tooth 21 to seat bracket 15 in an adhesive. Excess adhesive in areas adjacent the base of bracket 15 is removed, and the adhesive is then allowed to cure and fix bracket 15 thinly in place. This process usually takes a few seconds per tooth. The adhesive may be a bonding composition that requires both etching of tooth enamel (using, for example, phosphoric acid or a bisphosphonic acid) and a separate application of a primer to the tooth enamel; a bonding composition that requires the etching but not a separate application of primer; or a bonding composition that requires no treatment of the teeth other than cleaning.

An archwire may then be threaded between the brackets and, if needed, affixed with elastic or metal ligatures. Archwires are bent, shaped, and tightened frequently to achieve the desired results. A preferred embodiment of the invention uses nickel-titanium archwires and temperature-sensitive materials. When cold, the archwire is limp and flexible, easily threaded between brackets of any configuration. Once heated to body temperature, the archwire will stiffen and seek to retain its shape, creating, constant light force on the teeth. The ends of archwires are often connected to small appliances known as buccal tubes that are, in turn, secured to the patient's molar teeth. In many instances, a set of brackets, buccal tubes and an archwire is provided for each of the patient's upper and lower dental arches. The brackets, buccal tubes and archwires are commonly referred to collectively as “braces”.

On embodiment of the present invention may be used for wired braces made of stainless-steel optionally in combination with titanium. Elastic (rubber band) ties may be used to hold the wire onto the metal bracket 15 through the first slot 163 and/or the second slot 173. It should be appreciated that the present invention may also be used for self-ligating braces that do not require elastic ties, and wherein the wire goes through the bracket. Applications to clear braces are within the scope of the present invention. Clear braces serve as a cosmetic alternative to traditional metal braces by blending in more with the natural color of the teeth or having a less conspicuous or hidden appearance. Typically, these brackets are made of ceramic or plastic materials and function in a similar manner to traditional metal brackets. Clear elastic ties and white metal ties are typically used with these clear braces to help keep the appliances less conspicuous. Alternately, clear braces can be self-ligating, meaning the wire clips into the bracket without the need for ligatures Lingual braces are a cosmetic alternative in which bonding surface 152 is bonded to the back of the teeth making them externally invisible. Because the back surfaces of the teeth are more irregular, custom-made brackets can help to achieve a stronger bond between the tooth and bracket 10 or 15.

Referring back to FIG. 15, step (j) is disengaging the rigid link 40 and the customized rigid guide 30 from the orthodontic appliance 10 and the patient's dental arch 20 such as a tooth 21.

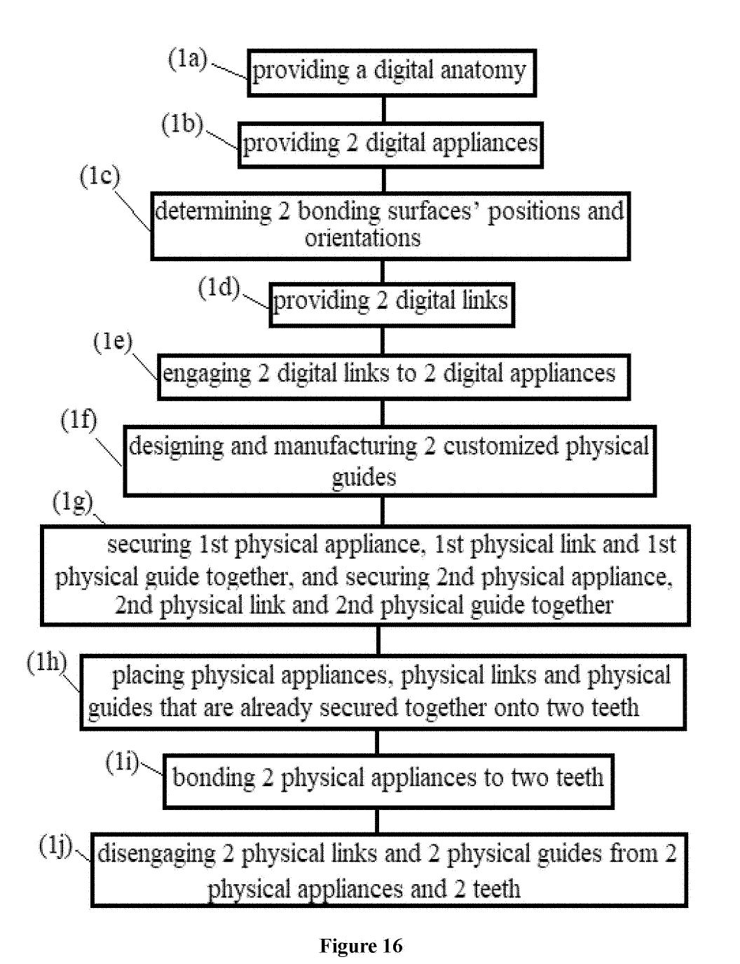

As described above, the dental apparatus may have the “single-link” design of as shown in FIG. 2. The present invention provides an orthodontic process as shown in FIG. 16 flow chart using such “single-link” design, for bonding of a first orthodontic appliance 101 having a first bonding surface 152a and a second orthodontic appliance 102 having a second bonding surface 152b, to a patients a first tooth 211 and a second tooth 212 respectively. The process includes (1a) providing a digital anatomy representing at least the patient's first tooth 211 and second tooth 212, (1b) providing two digital appliances representing the first orthodontic appliance 101 and the second orthodontic appliance 102; (1c) determining the two bonding surfaces' (152a, 152b) bonding positions and orientations on the patient's first tooth 211 and second tooth 212 respectively; (1c1) providing two digital links representing two standard rigid links 40 that are identical to each other, each of which comprises a first connector 41 and a second connector 42, wherein the second connector 42 can releasably engage with said first orthodontic appliance 101 or said second orthodontic appliance 102; (1e) digitally engaging the second connector 42 in one of the two standard rigid links 40 with said first orthodontic appliance 101, whereby a spatial relationship between the first connector 41 in said one of the standard rigid links 40 and the bonding surface 152a's bonding position and orientation on the patient's first tooth 211 is established and fixed; and digitally engaging the second connector 42 in another of the two standard rigid links 40 with said second orthodontic appliance 102, whereby a spatial relationship between the first connector 41 in said another of the two standard rigid links 40 and the bonding surface 152b's bonding position and orientation on the patient's second tooth 212 is established and fixed; (1f) designing and manufacturing a first customized guide 301 including a matching construction 31 that matches, and can releasably engage with, at least a portion 22 of the patient's first tooth 211, and only a first customized connecting structure 321, and designing and manufacturing a second customized guide 302 including ra matching construction 31 that matches, and can releasably engage with, at least a portion 22 of the patient's second tooth 212, and only a second customized connecting structure 322; wherein the first customized guide 301 is separated from the second customized guide 302; wherein, when the first connectors 41 of the two standard rigid links 40 engages with said first/second customized connecting structure 321/322, a spatial relationship between said first/second customized connecting structure 321/322 and the first/second bonding surface 152a/152b's bonding position and orientation on the patient's first/second tooth 211/212 is established and fixed, (1g) securing the first orthodontic appliance 101 and the second orthodontic appliance 102 to the two standard rigid links 40 by engaging the two appliances (101, 102) with the second connectors 42 of the two standard rigid links 40; and securing the two standard rigid links 40 to the first customized guide 301 and the second customized rigid guide 302 by engaging the first connectors 41 of the two standard rigid links 40 with said first customized connecting structure 321 and said second customized connecting structure 322; (1h) placing the first orthodontic appliance 101, one of the two standard rigid links 40 and said first customized connecting structure 321 that are already secured together, onto the patient's first tooth 211, wherein the matching construction 31 of said first customized guide 301 engages with said at least a portion 22 of the patient's first tooth 211; and placing the second orthodontic appliance 102, another of the two standard rigid links 40 and said second customized connecting structure 322 that are already secured together, onto the patient's second tooth 212, wherein the matching construction 31 of said second customized guide 302 engages with said at least a portion 22 of the patient's second tooth 212; (1i) bonding the first orthodontic appliance 101 to the patient's first tooth 211, and bonding the second orthodontic appliance 102 to the patient's second tooth 212; and (1j) disengaging the two standard rigid links 40 and the first and second customized rigid guides (301, 302) from the first and second orthodontic appliances (101, 102) and the patient's first and second teeth (211, 212).

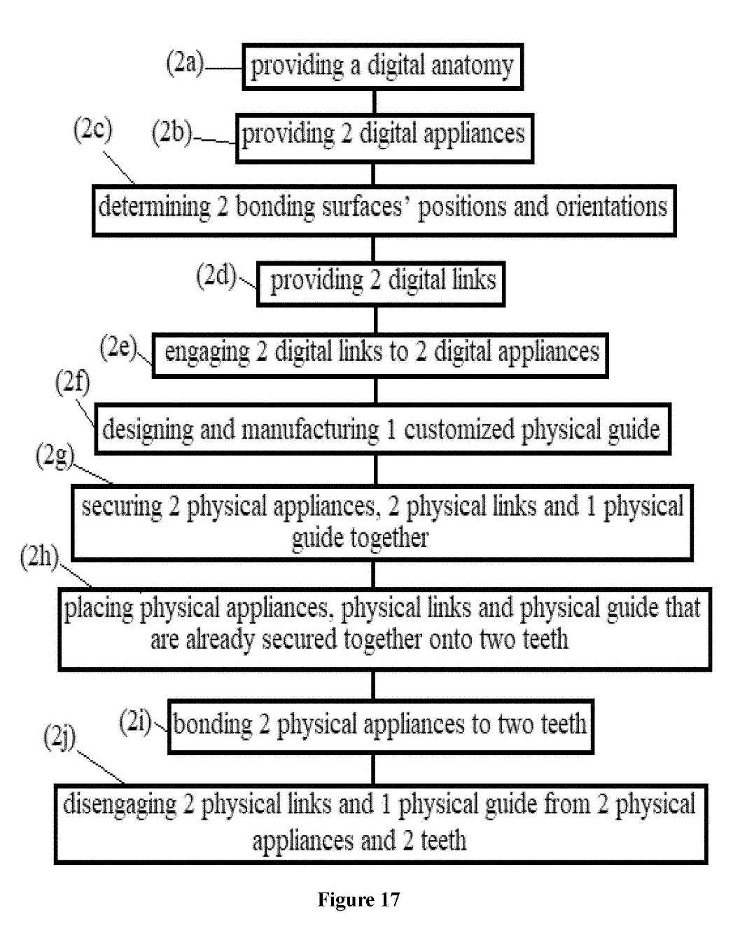

As described above, the dental apparatus may have the “multiple-link” design of as shown in FIGS. 3A and 3B The present invention provides an orthodontic process as shown in FIG. 17 flow chart, using such “multiple-link” design, for bonding of a first orthodontic appliance 101 having a first bonding surface 152a and a second orthodontic appliance 102 having a second bonding surface 152b, to a patient's a first tooth 211 and a second tooth 212 respectively. In this embodiment, the dentist can bond a plurality of appliances such as brackets to a patient's dental arch simultaneously, thereby avoiding the need to bond each appliance in individual fashion. In addition, the placement device of the invention helps to locate the appliances in their proper, intended positions such that adjustment of each appliance on the surface of the tooth before bonding is avoided. The process includes (2a) providing a digital anatomy representing at least the patient's first tooth 211 and second tooth 212; (2b) providing two digital appliances representing the first orthodontic appliance 101 and the second orthodontic appliance 102; (2c) determining the two bonding surfaces' (152a, 152b) bonding positions and orientations on the patient's first tooth 211 and second tooth 212 respectively; (2d) providing two digital links representing two rigid links 40 (standard or not), each of which comprises a first connector 41 and a second connector 42, wherein the second connector 42 can releasably engage with said first orthodontic appliance 101 or said second orthodontic appliance 102; (2e) digitally engaging the second connector 42 in one of the two rigid links 40 with said first orthodontic appliance 101, whereby a spatial relationship between the first connector 41 in said one of the rigid links 40 and the bonding surface 152a's bonding position and orientation on the patient's first tooth 211 is established and fixed; and digitally engaging the second connector 42 in another of the two rigid links 40 with said second orthodontic appliance 102, whereby a spatial relationship between the first connector 41 in said another of the two rigid links 40 and the bonding surface 152b's bonding position and orientation on the patient's second tooth 212 is established and fixed; (2f) designing and manufacturing a single-piece customized guide 30 including a matching construction 31 that matches, and can releasably engage with, at least a portion 22 of the patient's first/second tooth 211/212, a first customized connecting structure 321, and a second customized connecting structure 322; wherein, when the first connector 41 of the two rigid links 40 engages with said first/second customized connecting structure 321/322, ra spatial relationship between said first/second customized connecting structure 321/322 and the first/second bonding surface 152a/152b's bonding position and orientation on the patient's first/second tooth 211/212 is established and fixed; (2g) securing the first orthodontic appliance 101 and the second orthodontic appliance 102 to the two rigid links 40 by engaging the two appliances (101, 102) with the second connectors 42 of the two rigid links 40; and securing the two rigid links 40 to the first customized guide 301 and the second customized rigid guide 302 by engaging the first connectors 41 of the two rigid links 40 with said first customized connecting structure 321 and said second customized connecting structure 322; (2h) placing the first and second orthodontic appliances 101 and 102, the two rigid links 40 and the single-piece customized guide 30 that are already secured together, onto the patient's first and second teeth 211 and 212, wherein the matching construction 31 of said single-piece customized guide 30 engages with said at least a portion 22 of the patient's first and second teeth 211 and 212, (2i) bonding the first orthodontic appliance 101 to the patient's first tooth 211, and bonding the second orthodontic appliance 102 to the patient's second tooth 212; and (2j) disengaging the two rigid links 40 and the single-piece customized guide 30 from the first and second orthodontic appliances (101, 102) and the patient's first and second teeth (211, 212)

The process as shown in FIG. 17 may be expanded for bonding n more orthodontic appliances than those shown in FIG. 3A, to a patient's n more teeth than those shown in FIG. 3A, respectively. As a result, the customized guide 30 further includes n more customized connecting structures than those shown in FIG. 3A. Referring back to FIG. 3B, the dental apparatus comprises, in addition to the first rigid link 401 and the second rigid link 402, n more number of said rigid links 40 that are separate from each other for linking said n more customized connecting structures to said n more orthodontic appliances respectively. Each of said n more customized connecting structures is customized according to bonding position and orientation of a bonding surface in a corresponding orthodontic appliance selected from said n more orthodontic appliances on a corresponding tooth selected from said n more teeth. The number n can be any number between 1 and 14, 1≤n≤14, such as 2≤n≤14, 3≤n≤14, 4≤n≤14, 5≤n≤14, 6≤n≤14, 7≤n≤14, 8≤n≤14, 9≤n≤14, 10≤n≤14, 11≤11≤14, 12≤n≤14 such as n-13 The first rigid link 401, the second rigid link 402, as well as the n more rigid links 40 may be all identical to each other. Alternatively, some of the links are identical, while others are not. Each of the links can be unique in its own way, and none of the two links are identical.

In the foregoing specification, embodiments of the present invention have been described with reference to numerous specific details that may vary from implementation to implementation. The specification and drawings are, accordingly, to be regarded in an illustrative rather than a restrictive sense. The sole and exclusive indicator of the scope of the invention, and what is intended by the applicant to be the scope of the invention, is the literal and equivalent scope of the set of claims that issue from this application, in thee specific form in which such claims issue, including any subsequent correction.

1. A dental apparatus used for bonding an orthodontic appliance having a bonding surface configured for bonding to a patient's dental arch such as a tooth comprising:
a customized guide including a matching construction that matches, and can releasably engage with, at least a portion of the patient's dental arch, and at least one customized connecting structure; and
a rigid link for linking said customized, connecting structure to said orthodontic appliance, comprising a first connector and a second connector, wherein the first connector releasably engages with said customized connecting structure, and the second connector can releasably engage with said orthodontic appliance;
wherein the customized connecting structure is customized according to the bonding, surface's bonding position and orientation on the dental arch such as the tooth

2. The dental apparatus according to claim 1, which is used for bonding a first orthodontic appliance having a first bonding surface and a second orthodontic appliance having a second bonding surface, to a patient's a first tooth and a second tooth respectively, comprising:
a first customized guide including only a first customized connecting structure;
a second customized guide including only a second customized connecting structure, wherein the first customized guide is separated from the second customized guide;
two of said rigid links that are identical to each other for linking said first and second customized connecting structures to said first and second orthodontic appliances respectively;
wherein the first customized connecting structure is customized according to the first bonding surface's bonding position rand orientation on the first tooth; and
wherein the second customized connecting structure is customized according to the second bonding surface's bonding position and orientation on the second tooth

3. The dental apparatus according to claim 1, which is used for bonding a first orthodontic appliance and a second orthodontic appliance to a patient's a first tooth and a second tooth respectively, wherein the customized guide includes a first customized connecting structure and a second customized connecting structure; the dental apparatus comprising.
two of said rigid links including a first rigid link and a second rigid link that are separate from each other for linking said first and second customized connecting structures to said first and second orthodontic appliances respectively,
wherein the first customized connecting structure is customized according to the first bonding surface's bonding position and orientation on the first tooth; and
wherein the second customized connecting structure is customized according to the second bonding surface's bonding position and orientation on the second tooth

4. The dental apparatus according to claim 3, wherein the two of said rigid links that are identical to each other.

5. The dental apparatus according to claim 3, which is used for bonding n more orthodontic appliances to a patient's n more teeth respectively, wherein the customized guide further includes n more customized connecting structures,
wherein the dental apparatus further comprising n number of said rigid links that are separate from each other for linking said n more customized connecting structures to said n more orthodontic appliances respectively;
wherein each of said n more customized connecting structures is customized according to bonding position and orientation of a bonding surface in a corresponding orthodontic appliance selected from said n more orthodontic appliances on a corresponding tooth selected from said n more teeth; and
wherein 1≤n≤14.

6. The dental apparatus according to claim 3, wherein said first rigid link, said second rigid link, and said n number of said rigid links are identical.

7. The dental apparatus according to claim 1, wherein the orthodontic appliance is a bracket that includes
a base having a bonding surface configured for bonding to a patient's dental arch such as a tooth, and
a first pair of arms extending from the base, wherein the first pair of arms forms a first slot.

8. The dental apparatus according to claim 7, wherein the bracket further includes a second pair of arms extending from the base, wherein the second pair of arms forms a second slot, and wherein a valley is formed between the first pair of arms and the second pair of arms.

9. The dental apparatus according to claim 8, wherein the bracket further includes a first pair of hooks or barbs extending from the first pair of aims respectively, and a second pair of hooks or barbs extending from the second pair of arms respectively.

10. The dental apparatus according to claim 1, wherein the rigid link is configured for releasably engaging with the bracket in claim 7, and comprises a body, a first connector, and a second connector;
wherein the second connector comprises a first pair of pockets configured for the first pair of arms and optional hooks or barbs to fit into, and a first insert is formed between the first pair of pockets, wherein the first insert is configured for fitting into the first slot.

11. The dental apparatus according to claim 10, wherein the rigid link is configured for releasably engaging with the bracket in claim 8,
wherein the second connector further comprises a second pair of pockets configured for the second pair of arms and optional hooks or barbs to fit into, and a second insert is formed between the second pair of pockets, wherein the second insert is configured for fitting into the second slot,
wherein a ridge is formed between (A) the first pair of pockets and the first insert therebetween and (B) the second pair of pockets and the second insert therebetween, and
wherein the ridge is configured for releasably fitting into the valley.

12. The dental apparatus according to claim 1, wherein the rigid link is configured for releasably engaging with the bracket in claim 8, and comprises a body, a first connector, and a second connector;
wherein the second connector comprises a plate-shaped ridge having two sides, a first insert attached to one side of the ridge, and a second insert attached to another side of the ridge; and
wherein the first insert is configured for fitting into the first slot, the second insert is configured for fitting into the second slot, and the ridge is configured for releasably fitting into the valley.

13. The dental apparatus according to claim 12, further comprises a rubber band, wherein the body further comprises a groove, and wherein the rubber band wraps around the body and the bracket through the groove and secures the body and the bracket together.

14. The dental apparatus according to claim 1, wherein the rigid link comprises a body, a first connector, and a second connector;
wherein the first connector comprises a shoulder rand a head extending from the body;
wherein the customized guide is configured for releasably engaging with the rigid link, and includes a matching construction that matches, and can releasably engage with, at least a portion of the patient's dental arch such as a tooth, and at least one customized connecting structure;
wherein said customized connecting structure includes a flange having at least one aperture through the flange; and
wherein the head can insert and fit into the aperture until the flange contacts or sits on the shoulder.

15. An orthodontic process for bonding an orthodontic appliance such as a bracket to a patient's dental arch such as a tooth comprising
(a) providing a digital anatomy representing at least the patient's dental arch such as a tooth,
(b) providing a digital appliance representing an orthodontic appliance having a bonding surface configured for bonding to the patient's dental arch such as a tooth;
(c) determining the bonding surface's bonding position and orientation on the patient's dental arch such as a tooth;
(d) providing a digital link representing ra rigid link which comprises a first connector rand a second connector, wherein the second connector can releasably engage with said orthodontic appliance;
(e) digitally engaging the second connector with said orthodontic appliance, whereby a spatial relationship between the first connector and the bonding surface's bonding position and
orientation on the patient's dental arch such as a tooth is established and fixed,
(f) designing and manufacturing a customized rigid guide including a matching construction that matches, and can releasably engage with, at least a portion of the patient's dental arch such as a tooth, and at least one customized connecting, structure, wherein, when the first connector engages with said customized connecting structure, a spatial relationship between said customized connecting structure and the bonding surface's bonding position and orientation on the patient's dental arch such as ra tooth is established and fixed;
(g) securing the orthodontic appliance to the rigid link by engaging the orthodontic appliance with the second connector, and securing the rigid link to the customized rigid guide by engaging the first connector with said customized connecting structure;
(h) placing the orthodontic appliance, the rigid link and said customized connecting structure that are already secured together, onto the patient's dental arch such as a tooth, wherein the matching construction engages with said at least a portion of the patient's dental arch such as a tooth; and
(i) bonding the orthodontic appliance to the patient's dental arch such as a tooth.

16. The orthodontic process according to claim 15, for bonding of a first orthodontic appliance having a first bonding surface and a second orthodontic appliance having a second bonding surface, to a patient's a first tooth and a second tooth respectively, comprising:
(1a) providing a digital anatomy representing at least the patient's first tooth and second tooth;
(1b) providing two digital appliances representing, the first orthodontic appliance and the second orthodontic appliance;
(1c) determining the two bonding surfaces' bonding positions and orientations on the patient's first tooth and second tooth respectively;
(1d) providing two digital links representing two standard rigid links that are identical to each other, each of which comprises a first connector and a second connector, wherein the second connector can releasably engage with said first orthodontic appliance or said second orthodontic appliance;
(1e) digitally engaging the second connector in one of the two standard rigid links with said first orthodontic appliance, whereby a spatial relationship between the first connector in said one of the standard rigid links and the bonding surface's bonding position and orientation on the patient's first tooth is established and fixed, and digitally engaging the second connector in another of the two standard rigid links with said second orthodontic appliance, whereby a spatial relationship between the first connector in said another of the two standard rigid links and the bonding surface's bonding position and orientation on the patient's second tooth is established and fixed;
(1f) designing and manufacturing a first customized guide including a matching construction that matches, and can releasably engage with, at least a portion of the patient's first tooth, and only a first customized connecting structure, and designing and manufacturing a second customized guide including a matching construction that matches, and can releasably engage with, at least a portion of the patient's second tooth, and only a second customized connecting structure, wherein the first customized guide is separated from the second customized guide;
wherein, when the first connectors of the two standard rigid links engages with said first/second customized connecting structure, a spatial relationship between said first/second customized connecting structure and the first/second bonding surface's bonding position and orientation on the patient's first/second tooth is established and fixed;
(1g) securing the first orthodontic appliance and the second orthodontic appliance to the two standard rigid links by engaging the two appliances with the second connectors of the two standard rigid links; and securing the two standard rigid links to the first customized guide and the second customized rigid guide by engaging the first connectors of the two standard rigid links with said first customized connecting structure and said second customized connecting structure,
(1h) placing the first orthodontic appliance, one of the two standard rigid links and said first customized connecting structure that are already secured together, onto the patient's first tooth, wherein the matching construction of said first customized guide engages with said at least a portion of the patient's first tooth, and placing the second orthodontic appliance, another of the two standard rigid links and said second customized connecting structure that are already secured together, onto the patient's second tooth, wherein the matching construction of said second customized guide engages with said at least a portion of the patient's second tooth; and
(1i) bonding the first orthodontic appliance to the patient's first tooth, and bonding the second orthodontic appliance to the patient's second tooth.

17. The orthodontic process according to claim 15, for bonding of a first orthodontic appliance having a first bonding surface and a second orthodontic appliance having a second bonding surface, to a patient's a first tooth and a second tooth respectively, comprising:
(2a) providing a digital anatomy representing at least the patient's first tooth and second tooth;
(2b) providing two digital appliances representing the first orthodontic appliance and the second orthodontic appliance;
(2c) determining the two bonding surfaces' bonding positions and orientations on the patient's first tooth and second tooth respectively;
(2d) providing two digital links representing two rigid links that are optionally identical to each other, each of which comprises a first connector and a second connector, wherein the second connector can releasably engage with said first orthodontic appliance or said second orthodontic appliance;
(2e) digitally engaging the second connector in one of the two rigid links with said first orthodontic appliance, whereby a spatial relationship between the first connector in said one of the rigid links and the bonding surface's bonding position and orientation on the patient's first tooth is established and fixed; and digitally engaging the second connector in another of the two rigid links with said second orthodontic appliance, whereby a spatial relationship between the first connector in said another of the two rigid links and the bonding surface's bonding position and orientation on the'patient's second tooth is established and fixed;
(2f) designing and manufacturing a single-piece customized guide including a matching construction that matches, and can releasably engage with, at least a portion of the patient's first/second tooth, a first customized connecting structure, and a second customized connecting structure; wherein, when the first connector of the two rigid links engages with said first/second customized connecting structure, a spatial relationship between said first/second customized connecting structure and the first/second bonding surface's bonding position and orientation on the patient's first/second tooth is established and fixed;
(2g) securing the first orthodontic appliance and the second orthodontic appliance to the two rigid links by engaging the two appliances with the second connectors of the two rigid links; and securing the two rigid links to the first customized guide and the second customized rigid guide by engaging the first connectors of the two rigid links with said first customized connecting structure and said second customized connecting, structure;
(2h) placing the first and second orthodontic appliances and, the two rigid links and the single-piece customized guide that are already secured together, onto the patient's first and second teeth and, wherein the matching construction of said single-piece customized, guide engages with said at least a portion of the patient's first and second teeth and, and
(2i) bonding the first orthodontic appliance to the patient's first tooth, and bonding the second orthodontic appliance to the patient's second tooth.

18. An orthodontic rigid link comprising a body, a first connector, rand a second connector, wherein the first connector comprises a shoulder and a head extending from the body.

19. The orthodontic rigid link according to claim 18, wherein the second connector comprises a first pair of pockets, and a first insert is formed between the first pair of pockets.

20. The orthodontic rigid link according to claim 19, wherein the second connector further comprises a second pair of pockets, and a second insert is formed between the second pair of pockets; and wherein a ridge is formed between (A) the first pair of pockets and the first insert therebetween and (B) the second pair of pockets and the second insert therebetween.

21. The orthodontic rigid link according to claim 18, wherein the second connector comprises a plate-shaped ridge having two sides, a first insert attached to one side of the ridge, and a second insert attached to another side of the ridge.

22. The orthodontic rigid link according to claim 18, further comprising a rubber band, wherein the body further comprises a groove, and wherein the rubber band wraps around the body and a bracket through the groove and secures the body and the bracket together.
